(19) United States
(12) Patent Application Publication
(10) Pub. No.: US 2020/0043493 A1
(43) Pub. Date: Feb. 6, 2020

(54) TRANSLATION DEVICE

(71) Applicant: Panasonic Intellectual Property Management Co., Ltd., Osaka (JP)

(72) Inventor: TOMOKAZU ISHIKAWA, Osaka (JP)

(21) Appl. No.: 16/599,150

(22) Filed: Oct. 11, 2019

Related U.S. Application Data
(63) Continuation of application No. PCT/JP2018/015434, filed on Apr. 12, 2018.

(30) Foreign Application Priority Data
Apr. 27, 2017 (JP) 2017-088604

(51) Int. Cl. G10L 15/22; G10L 13/04; G06F 17/28

(52) U.S. Cl. CPC G10L 15/22; G06F 17/289; G10L 13/043

(57) ABSTRACT

A storage unit stores a target term and a target translated term that is a translation of the target term. The storage unit further stores a substitute term and a substitute translated term that is a translation of the substitute term. The target term is to be replaced with the substitute term. The target and substitute terms are expressed in a first language. The target and substituted translated terms are expressed in a second language. A replacing unit replaces the target term in an original sentence with the substitute term to generate a processed sentence. A communication unit acquires a provisional translation from a first external device that has a translation function. A restoring unit changes, in the provisional translation, the substitute translated term to the target translated term to generate a target translation. A display unit displays the target translation with the target translated term emphasized.

### TECHNICAL FIELD

The present disclosure relates to a translation device that translates an input sentence from one language into another language.

### BACKGROUND ART

PTL 1 discloses an electronic dictionary device that translates English text that a user has input into Japanese text. If a preregistered word is contained in the input English text, this electronic dictionary device displays a translation result, or the Japanese text, with a translation of the registered word replaced with a related English word. In short, the electronic dictionary device displays the registered word in English but displays a translation of the remaining words in Japanese. For example, if “cheap” is registered as a registered word, the electronic dictionary device outputs a Japanese sentence including an English word “korewa cheap kaban desu.”, as a translation result of an English sentence “this is a cheap bag.”. Furthermore, in response to a press on a translation/decision key, the electronic dictionary device of PTL 1 underlines the registered word in the displayed English text and also its translation in the displayed Japanese text. This enables a user to learn the languages of the registered word.

### CITATION LIST

### Patent Literature

PTL 1: Japanese Patent No. 4929632

### SUMMARY

The present disclosure provides a translation device that acquires a sentence (e.g., spoken sentence) expressed in a first language, and outputs a translation of the sentence in a second language with visibility of a notable term improved.

A translation device of the present disclosure acquires an original sentence expressed in a first language and displays a target translation that is a translation of the original sentence expressed in a second language. This translation device includes a storage unit, a replacing unit, a communication unit, a restoring unit, and a display. The storage unit stores first information and second information. The first information contains a target term and a target translated term that is a translation of the target term in association with each other. The second information contains a substitute term and a substitute translated term that is a translation of the substitute term in association with each other. The target term is to be replaced with the substitute term. The target and substitute terms are expressed in the first language. The target and substitute translated terms are expressed in the second language. The replacing unit replaces the target term in the original sentence with the substitute term to generate a processed sentence to be translated. The communication unit outputs the processed sentence to a first external device and acquires from the first external device a provisional translation expressed in the second language that is a translation of the processed sentence. The first external device has a function of making translation from the first language into the second language. The restoring unit changes, in the provisional translation, the substitute translated term to the target translated term to generate the target translation. The display unit displays the target translation with the target translated term emphasized

According to the present disclosure, a translation device can provide a notable term with improved visibility. As a result, a user can easily find a notable specific term in displayed text.

### BRIEF DESCRIPTION OF DRAWINGS

FIG. 1 is a view of an appearance of a translation device according to a first exemplary embodiment.

FIG. 2 is a block diagram illustrating an electrical configuration of a translation system according to the first exemplary embodiment.

FIG. 3 is an explanatory diagram of a replacement process.

FIG. 4 is a diagram of an example of registered word dictionaries.

FIG. 5 is a diagram of an example of a substitute word dictionary.

FIG. 6 is a diagram of an example of replacement information.

FIG. 7 is a flowchart of a translation process performed by a controller in the translation device according to the first exemplary embodiment.

FIG. 8 is a flowchart of steps of generating and displaying a target translation in a regular process according to the first exemplary embodiment.

FIG. 9 is a flowchart of steps of generating and displaying a target translation in the replacement process.

FIG. 10A is an explanatory diagram illustrating replacement of a registered term.

FIG. 10B is an explanatory diagram illustrating restore of a registered translated term.

FIG. 11A is a view of a display example of a translation result according to the first exemplary embodiment.

FIG. 11B is a view of another display example of the translation result according to the first exemplary embodiment.

FIG. 12 is a flowchart of steps of generating and displaying a target translation in a regular process according to a second exemplary embodiment.

FIG. 13 is a view of a display example of a translation result according to the second exemplary embodiment.

### DESCRIPTION OF EMBODIMENT

Some exemplary embodiments will be described below in detail with reference to the accompanying drawings as appropriate. In some instances, excessively detailed descriptions will be skipped. For example, a detailed description of known matters and a duplicate description of substantially identical configurations may be skipped. A reason for this is to avoid unnecessary redundancy of the following description and to facilitate understanding of those skilled in the art.

The inventor provides the accompanying drawings and the following description to help those skilled in the art to fully comprehend the present disclosure, but does not intend to limit subject matters recited in the claims with the drawings and the description.

### First Exemplary Embodiment

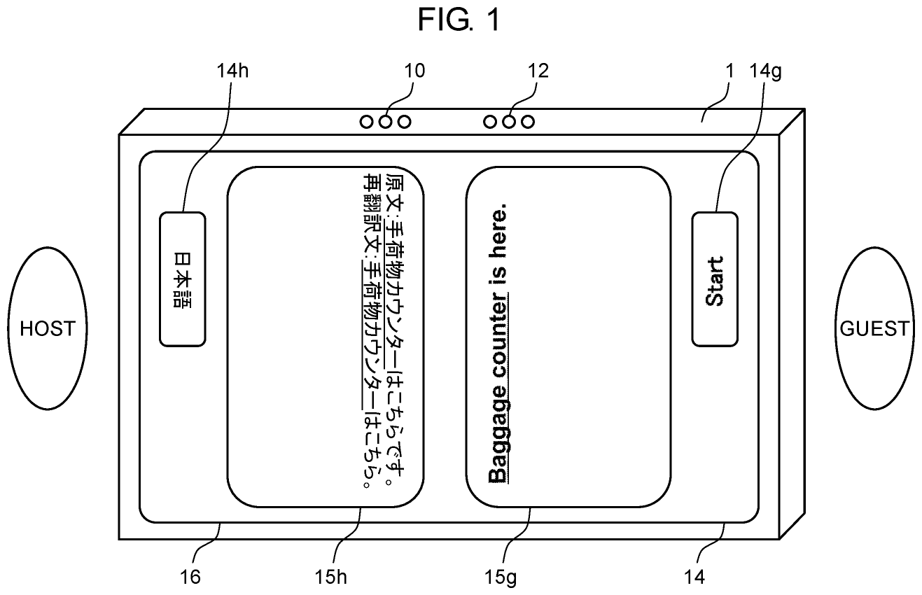

With reference to FIGS. 1 to 11B, a first exemplary embodiment will be described below.

### 1-1. Configuration

FIG. 1 is a view of an appearance of a translation device according to a first exemplary embodiment. Translation device 1 illustrated in FIG. 1, which is a tablet type of a translation device, for example, translates conversation between two users speaking in different languages. In short, translation device 1 can make translation from a first language (e.g., Japanese) into a second language (e.g., English) and also from the second language (e.g., English) into the first language (e.g., Japanese). In some exemplary embodiments described below, translation device 1 translates face-to-face conversation between a host (e.g., guide) who speaks Japanese and a guest (e.g., traveler) speaks English.

Translation device 1 includes microphone 10, speaker 12, display 14, and touch panel 16. Both microphone 10 and speaker 12 are disposed, for example, near openings on a side surface of translation device 1. Both display 14 and touch panel 16 are disposed on a main surface of translation device 1. Near one end of display 14 in a longitudinal direction (e.g., adjacent to the host) is an area in which both speech icon 14h and display area 15h are disposed. Near the other end of display 14 in the longitudinal direction (e.g., adjacent to the guest) is an area in which both speech icon 14g and display area 15g are displayed. A user can perform a touch operation on speech icons 14h, 14g.

Speech icon 14h is an operation icon to be operated by the host to specify start and end points of a speech that the host makes in Japanese (first language), namely, that the host inputs into translation device 1. Speech icon 14g is an operation icon to be operated by the guest to specify start and end points of a speech that the guest makes in English (second language), namely, that the guest inputs into translation device 1. Each of display areas 15h, 15g is an area in which results of voice recognition, translation, or reverse translation, for example, is to be displayed in the form of a character string.

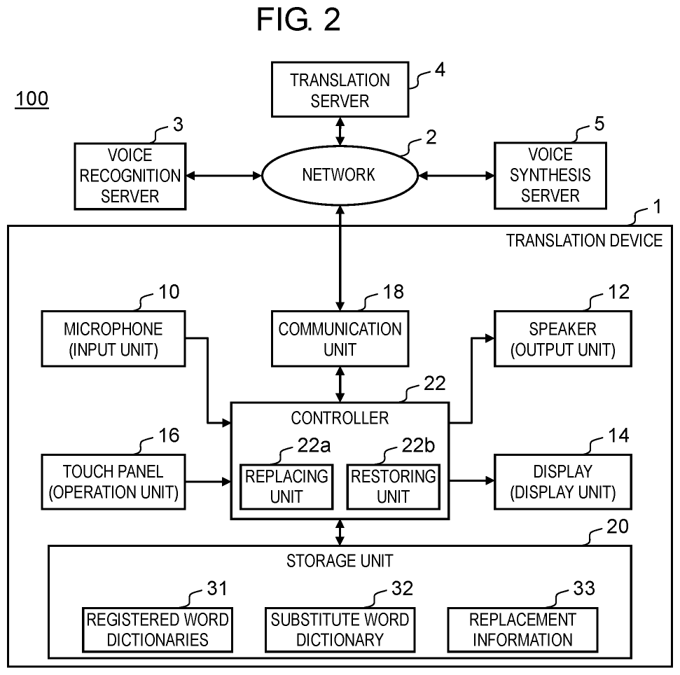

FIG. 2 is a block diagram illustrating an electrical configuration of a translation system according to the first exemplary embodiment. Translation system 100 of the present disclosure includes translation device 1 illustrated in FIG. 1, voice recognition server 3, translation server 4, and voice synthesis server 5. Translation device 1 individually conducts data communication with voice recognition server 3, translation server 4, and voice synthesis server 5 via network 2 such as the Internet.

Voice recognition server 3 is a server that receives digital voice data from translation device 1 via network 2, then recognizes a voice in the received digital voice data, and generates voice recognition data (text data of a spoken sentence) in the form of a character string. Herein, voice recognition server 3 is an example of a second external device.

Translation server 4 is a server that receives the voice recognition data from translation device 1 via network 2, then translates the received voice recognition data, and generates translation data (text data on a translated sentence) in the form of a character string. Translation server 4 is an example of an external device that has a function of making translation from Japanese (first language) into English (second language) and also from English into Japanese.

Voice synthesis server 5 is a server that receives the translation data in the form of a character string from translation device 1 via network 2, then synthesizes voices of the received translation data in the form of a character string, and generates a voice signal.

Translation device 1 includes microphone 10, speaker 12, display 14, touch panel 16, communication unit 18, storage unit 20, and controller 22.

Microphone 10 is a device that converts voice sound into digital voice data. More specifically, microphone 10 converts voice sound into a voice signal (analog electrical signal) and further converts the voice signal into digital voice data with an analog-digital (AD) converter. Microphone 10 is an example of an input unit via which a speech (voice) or a spoken sentence (text) is to be input into translation device 1.

Communication unit 18 is a communication module that conducts data communication with voice recognition server 3, translation server 4, and voice synthesis server 5 via network 2 in conformity with a communication scheme, such as Bluetooth (registered trademark), wireless Fidelity (Wi-Fi) (registered trademark), third-generation (3G), long term evolution (LTE) (registered trademark), or the institute of electrical and electronics engineers (IEEE) 802.11.

Storage unit 20 is a recording medium formed of one or a combination of a flash memory, a ferroelectric memory, a hard disk drive (HDD), a solid state drive (SSD), and a random access memory (RAM), for example. Storage unit 20 stores the digital voice data from microphone 10, the voice recognition data, and translation data. Storage unit 20 also stores various program to be executed by controller 22. In this exemplary embodiment, storage unit 20 stores registered word dictionaries 31, substitute word dictionary 32, and replacement information 33. Registered in each registered word dictionary 31 are specific target terms (registered terms) that are to be replaced. Contained in substitute word dictionary 32 are terms (substitute terms) to be used instead of the targets to be replaced when translation is made. Replacement information 33 is information that indicates a relationship between terms to be used before the replacement and terms to be used after the replacement.

Controller 22 includes replacing unit 22a and restoring unit 22b. Replacing unit 22a replaces a registered term contained in text data (voice recognition data) on a spoken sentence with a substitute term, thereby generating a processed sentence that is a sentence to be translated. Restoring unit 22b changes, in text data of a provisional translation, a substitute translated term to the registered translated term. The provisional translation is a translation of the processed sentence. The substitute translated term is a translation of the substitute term. The registered translated term is a translation of the registered term. Controller 22, which may be formed of a central processing unit (CPU) or a micro processing unit (MPU), for example, executes various programs stored in storage unit 20 to control an overall operation of translation device 1. In this exemplary embodiment, the function of controller 22 is implemented with cooperation of hardware and software. Alternatively, the function of controller 22 may be implemented only with a hardware circuit dedicatedly designed to realize a predetermined function. In short, controller 22 may be formed of one of the CPU and the MPU or one of a digital signal processor (DSP), a field-programmable gate array (FPGA), and an application specific integrated circuit (ASIC), for example.

Speaker 12 is a device that converts an electrical signal to voice sound. Speaker 12 outputs the voice sound, based on a voice signal (electrical signal) transmitted from controller 22. Speaker 12 is an example of an output unit that outputs voice sound or text indicating a translation result.

Display 14, which may be a liquid crystal or organic electroluminescence (EL) display device, is a device that displays an image. Display 14 displays an image indicated by the voice recognition data, the translation data, or the reverse translation data from controller 22, within each of display areas 15h, 15g. Display 14 is an example of a display unit that displays the voice recognition data, the translation data, and the reverse translation data toward the host and the guest. Display 14 also displays speech icons 14h, 14g described above.

Touch panel 16, which is an operation unit to be operated by the user, receives a user's command. Touch panel 16 is disposed and stacked on display 14.

### 1-2. Summary of Replacement Process

Translation system 100 in this exemplary embodiment has a function of temporarily replacing one or more terms in a spoken sentence with other terms (substitute terms) and then translating this spoken sentence. Herein, the process in which one or more terms in a spoken sentence are temporarily replaced with other terms (substitute terms) before the translation is referred to as the “replacement process”. In general, in order to provide accurate machine translation from the first language into the second language, it is necessary to teach extremely many terms to a translation engine in translation server 4. However, it may be difficult to teach so many terms in the translation engine within a short period of time by registering those terms. In addition, if non-generic (specific) terms are taught to the translation engine, those specific terms may affect translation of other generic terms. As a result, the translation engine might fail to translate such generic terms correctly. For this reason, translation system 100 of the present disclosure performs the replacement process on specific terms. Thus, the translation engine outputs a translation result of an entire spoken sentence without translating such specific terms. More specifically, if a spoken sentence contains a specific term, translation system 100 of the present disclosure replaces this specific term with a generic term (substitute term) to generate a processed sentence that is a sentence to be translated, and then translates the processed sentence. Following this, translation system 100 performs a process of restoring a translation of the original specific term, based on a translation of the generic term (substitute term) contained in a translation result of the sentence.

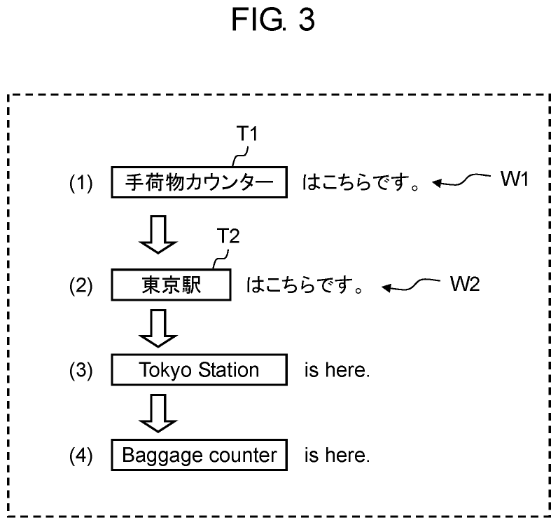

FIG. 3 illustrates a flow example of the replacement process described above. In the example of FIG. 3, term T1 meaning “baggage counter” in Japanese can be regarded as a specific target term. In addition, term T2 meaning “Tokyo station” in Japanese can be regarded as a generic term (substitute term) to be used instead of term T1. Japanese term T1 and its English translation “baggage counter” are both stored in translation device 1 in advance. First, when a speaker speaks sentence W1 meaning “baggage counter is here” in Japanese (see FIG. 3(1)) as an original sentence, term T1 designated as a specific target term is replaced with term T2 designated as a substitute term. Then, text data (voice recognition data) on sentence W2 meaning “Tokyo station is here” in Japanese is generated as a processed sentence (see FIG. 3(2)). This text data is translated by the translation engine in translation server 4 into text data (translation data or a provisional translation that is a translated sentence of the processed sentence) “Tokyo station is here” in English (see FIG. 3(3)). Finally, the “Tokyo station” is replaced with “Baggage counter” corresponding to a translation of term T1 that has been replaced with the substitute term (term T2), and “Baggage counter is here.” in English is output as a target translation that is a translation of the original sentence (see FIG. 3(4)). In the replacement process, as described above, term T1 to be replaced is not translated by the translation engine, and a translation result of sentence W1, which is a spoken sentence, is output.

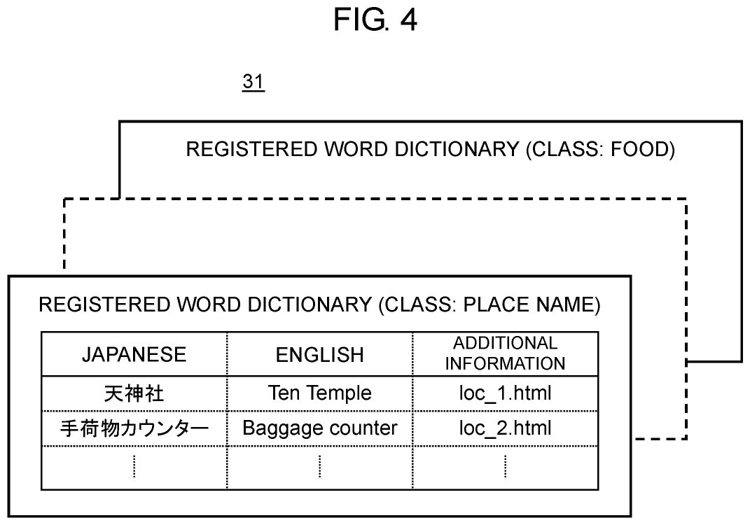

To make translation in the replacement process as illustrated in FIG. 3, translation device 1 in this exemplary embodiment includes registered word dictionaries 31, substitute word dictionary 32, and replacement information 33. With reference to FIGS. 4 to 6, a description will be given of registered word dictionaries 31, substitute word dictionary 32, and replacement information 33.

FIG. 4 illustrates an example of registered word dictionaries 31. Registered in each registered word dictionary 31 are specific target terms. Such specific target terms refer to non-generic terms, examples of which include: technical terms used only in any specific fields; and terms used only in certain places or regions. The specific terms include: terms that the host expects to draw guest's interest; and terms that the translation engine may have difficulty translating accurately with machine translation. Terms included in each registered word dictionary 31 include words and phrases. Each registered word dictionary 31 contains: translation groups of terms expressed in a plurality of languages; and additional information related to those terms. Herein, of the translation groups of terms expressed in a plurality of languages in each registered word dictionary 31, terms expressed in a speaker's language are referred to as “registered terms”, whereas terms expressed in languages used for translation are referred to as “registered translated terms”. Registered word dictionaries 31 are provided for respective classes that indicate types of the registered terms. The classes used to classify terms refer to categories (genres) of objects indicated by the terms. Examples of the classes include place names and foods. The additional information refers to, for example, if the class is a place name, information regarding pictures of the place indicated by the registered term and transportations to the place.

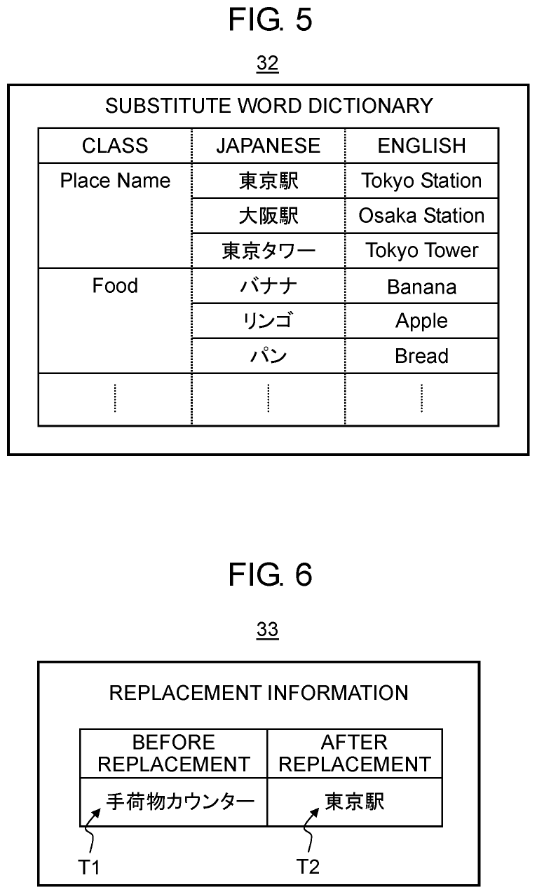

FIG. 5 illustrates an example of substitute word dictionary 32. Substitute word dictionary 32 contains substitute terms to be used for translation instead of registered terms. The substitute terms contained in substitute word dictionary 32 are generic terms that can be translated accurately by the translation engine. The substitute terms contained in substitute word dictionary 32 include words and phrases. Terms contained in substitute word dictionary 32 are expressed, as translation groups, in the same languages (Japanese and English in this exemplary embodiment) as in each registered word dictionary 31. Herein, of the terms expressed in the plurality of languages in substitute word dictionary 32, terms expressed in a speaker's language are referred to as “substitute terms”, whereas terms expressed in languages used for the translation are referred to as “substitute translated terms”. Substitute word dictionary 32 contains one or more substitute terms and their translations for each class.

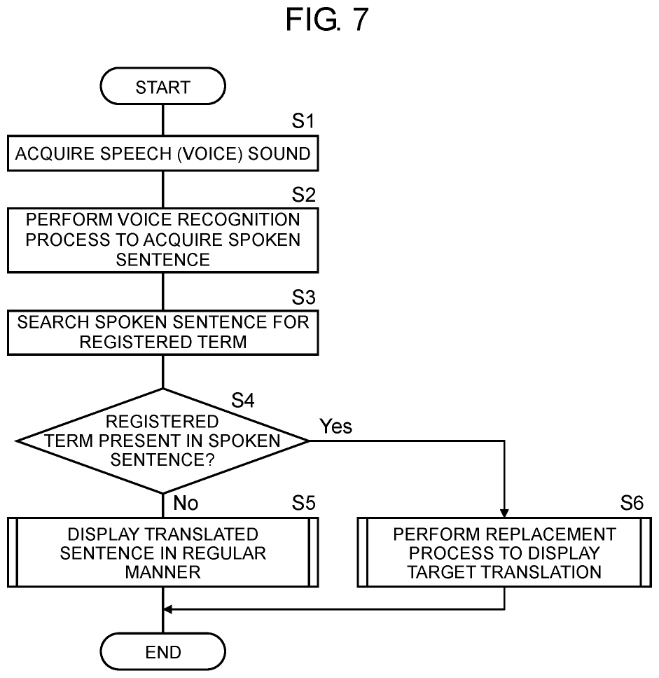

FIG. 6 illustrates an example of replacement information 33. In replacement information 33, terms used before the replacement (registered terms) are related to terms used after the replacement (substitute terms). If term T1 is replaced with term T2 as illustrated in FIG. 3, term T1 is recorded as the term before the replacement, and term T2 is recorded as the term after the replacement.

### 1-3. Operation

### [1-3-1. Overall Operation]

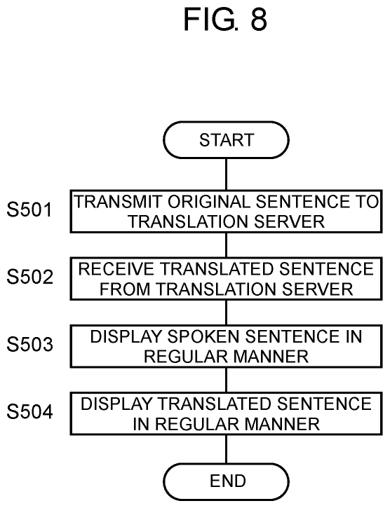

With reference to FIGS. 7 to 11B, a description will be given of an operation performed by translation system 100 configured above. In this exemplary embodiment, the translation engine is installed in translation server 4. Translation device 1 transmits text data (voice recognition data in the form of a character string) on a spoken sentence to translation server 4. Then, translation device 1 acquires text data (translation data in the form of a character string) on the translated sentence that indicates a translation result from translation server 4.

FIG. 7 is a flowchart of an operation performed by controller 22 in translation device 1. Controller 22 in translation device 1 acquires digital voice data according to a speech (voice sound) made by a speaker through microphone 10 (S1).

Controller 22 performs a voice recognition process to acquire a spoken sentence (S2). More specifically, controller 22 transmits the digital voice data to voice recognition server 3 via network 2. Voice recognition server 3 recognizes a voice in the received digital voice data to generate text data on the spoken sentence. Translation device 1 receives the text data on the spoken sentence from voice recognition server 3 via network 2.

Controller 22 searches the spoken sentence for a registered term contained in registered word dictionaries 31 (S3). Controller 22 determines whether a registered term is present in the spoken sentence (S4). When no registered term is present in the spoken sentence (No at S4), controller 22 performs a regular process to generate and display a translated sentence (S5). When a registered term is present in the spoken sentence (Yes at S4), controller 22 performs a replacement process to generate and display a target translation (S6).

Simultaneously with the displaying of the target translation, controller 22 may output voice sound of the target translation. In this case, controller 22 transmits the text data on the target translation generated at Step S5 or S6 to voice synthesis server 5 via network 2. Based on the text data on the target translation received from translation device 1, voice synthesis server 5 performs voice synthesis to generate a voice signal. Then, voice synthesis server 5 transmits the voice signal to translation device 1 via network 2. Controller 22 receives the voice signal from voice synthesis server 5 and then outputs voice sound of the translation result based on the voice signal via speaker 12.

### [1-3-2. Translation in Regular Process]

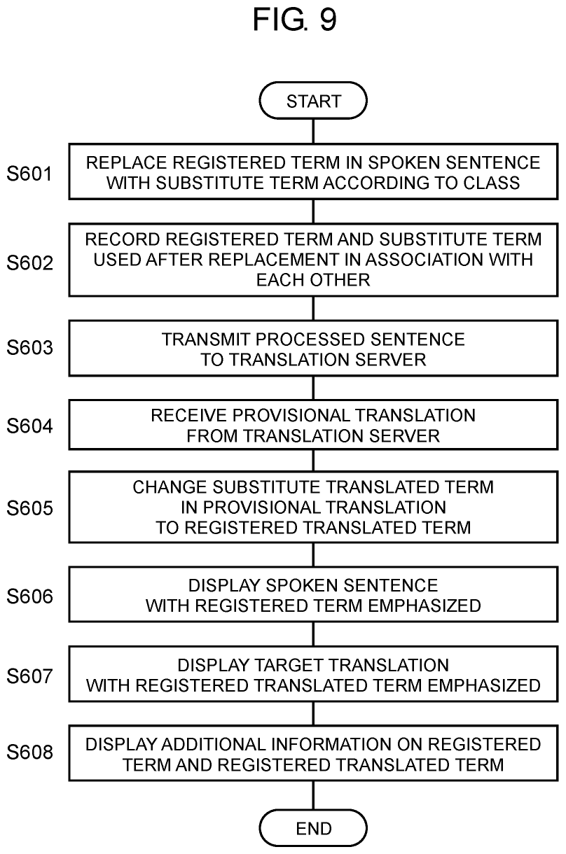

With reference to FIG. 8, a concrete description will be given of the regular process (S5) in which a target translation is generated and displayed. FIG. 8 illustrates details of the regular process (S5) in which a target translation is generated and displayed when no registered term is present in a spoken sentence (No at S4). In this regular process, controller 22 translates a spoken sentence without replacing words in the spoken sentence. As in the example of FIG. 3, for example, when the speaker (host) speaks sentence W2 as an original sentence, the translation engine translates text of sentence W2 into text “Tokyo Station is here.”.

Controller 22 in translation device 1 transmits the text data on the spoken sentence (original sentence) to translation server 4 via network 2 (S501). Translation server 4 translates the spoken sentence to generate text data on the target translation. Translation server 4 transmits the text data on the target translation to translation device 1 via network 2. Translation device 1 receives the text data on the target translation from translation server 4 via network 2 (S502).

Controller 22 causes display 14 to display the spoken sentence (S503) and the target translation as the translation result (S504). A display method performed at Step S503 and S504 is a display method performed in a regular manner, for example, in which characters in the spoken sentence and the target translation are displayed in black. The displaying of the spoken sentence (S503) and the displaying of the translated sentence (S504) may be performed either simultaneously or in a sequence. For example, the spoken sentence may be displayed before the text of the target translation is received from translation server 4. This means that Step S503 may be performed before Step S502.

### [1-3-3. Translation in Replacement Process]

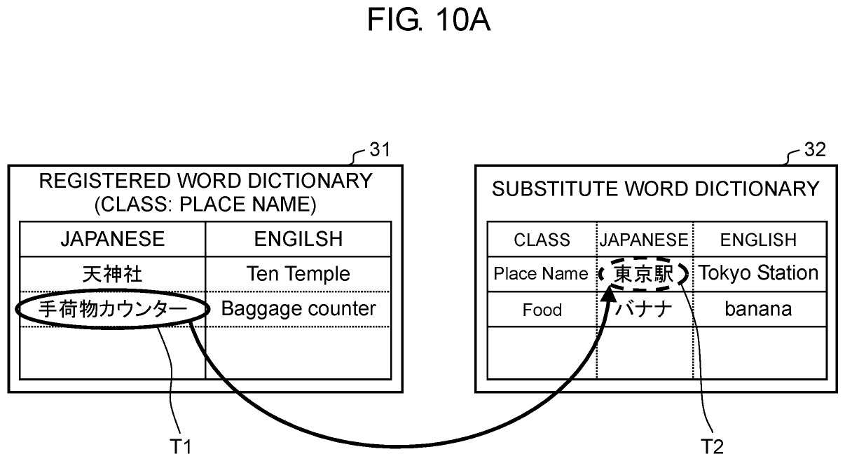

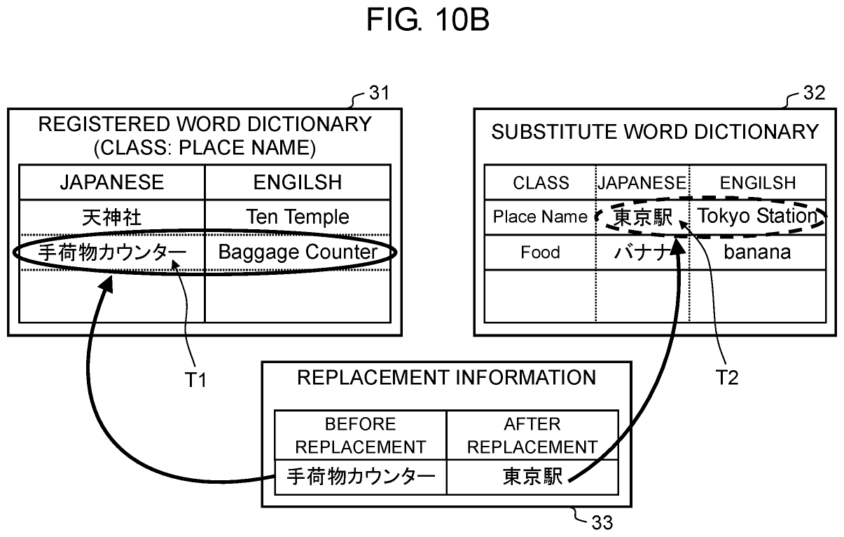

With reference to FIGS. 9, 10A, and 10B, a concrete description will be given of the replacement process (S6) in which a target translation is generated and displayed. FIG. 9 illustrates details of the replacement process (S6) in which a target translation is generated and displayed when a registered term is present in a spoken sentence (Yes at S4). FIG. 10A is an explanatory diagram of the replacement of a registered term; FIG. 10B is an explanatory diagram of restoring of a registered translation term. In the description below, it is expected that the host (guide) makes a speech (voice) in Japanese, and then translation system 100 translates this speech into English and delivers the translation result to the guest (traveler). As a specific example, as illustrated in FIG. 3, the host speaks sentence W1 as an original sentence, and then translation system 100 displays the translation result “Baggage counter is here.” toward the guest.

When a registered term is present in the spoken sentence, as illustrated in FIG. 9, controller 22 in translation device 1 replaces the registered term in the spoken sentence with a substitute term according to the class (S601). As illustrated in FIG. 10A, term T1 is registered in registered word dictionaries 31 as the registered term. Term T1 belongs to a class “place name”. Term T2 is registered in substitute word dictionary 32 as a substitute term belonging to the class “place name”. Therefore, based on the class “place name”, controller 22 selects term T2, as the substitute term, from substitute word dictionary 32. Then, controller 22 replaces term T1 in the spoken sentence, or sentence W1, with term T2.

Controller 22 relates the registered term to the substitute term used after the replacement, and records the registered and substitute terms as replacement information 33 (S602). As illustrated in FIG. 10B, for example, term T1 is recorded in replacement information 33 as the term used before the replacement, and term T2 is recorded in replacement information 33 as the term after the replacement.

Controller 22 transmits text data on a processed sentence in which the spoken sentence has been replaced to translation server 4, via network 2 (S603). In this case, controller 22 transmits text data on sentence W2 that contains term T2 as the substitute term. Translation server 4 receives the text data on the processed sentence and then translates this sentence to generate text data on a provisional translation. In this case, translation server 4 translates sentence W2 into “Tokyo Station is here.”. Translation server 4 transmits the text data on the provisional translation to translation device 1 via network 2. Controller 22 in translation device 1 receives the text data on the provisional translation from translation server 4 via network 2 (S604).

Controller 22 changes the substitute translated term in the provisional translation to a registered translated term (S605). In this case, controller 22 changes “Tokyo Station is here.”, to “Baggage counter is here.”. More specifically, controller 22 refers to replacement information 33 as illustrated in FIG. 10B and identifies term T2 as the substitute term that has been used for the replacement. Controller 22 reads a translation “Tokyo Station” related to term T2 from substitute word dictionary 32 and searches the provisional translation for “Tokyo Station”. Then, controller 22 refers to replacement information 33 and identifies term T1 as the registered term before the replacement. Controller 22 reads a translation “Baggage counter” related to term T1 from registered word dictionaries 31. Controller 22 replaces “Tokyo Station” in the provisional translation with “Baggage counter”.

Controller 22 causes display 14 to display the spoken sentence within display area 15h (adjacent to the host) with the registered term emphasized (S606). Likewise, controller 22 causes display 14 to display the target translation within display area 15g (adjacent to the guest) with the registered translated term emphasized (S607). Examples of the emphasizing display method include displays with an underline, a surrounding line, a slanted letter, a capitalized letter, a bold letter, and a chromatic color (if an achromatic color is used for the normal display). In addition, controller 22 acquires additional information related to the registered term, from registered word dictionaries 31. Then, controller 22 causes display 14 to display this additional information within display area 15g (adjacent to the guest) (S608). The displaying of the spoken sentence (S606), the displaying of the target translation (S607), and the displaying of the additional information (S608) may be performed either simultaneously or in a sequence. For example, the spoken sentence may be displayed before the text of the provisional translation is received from translation server 4. This means that Step S606 may be performed before Step S604.

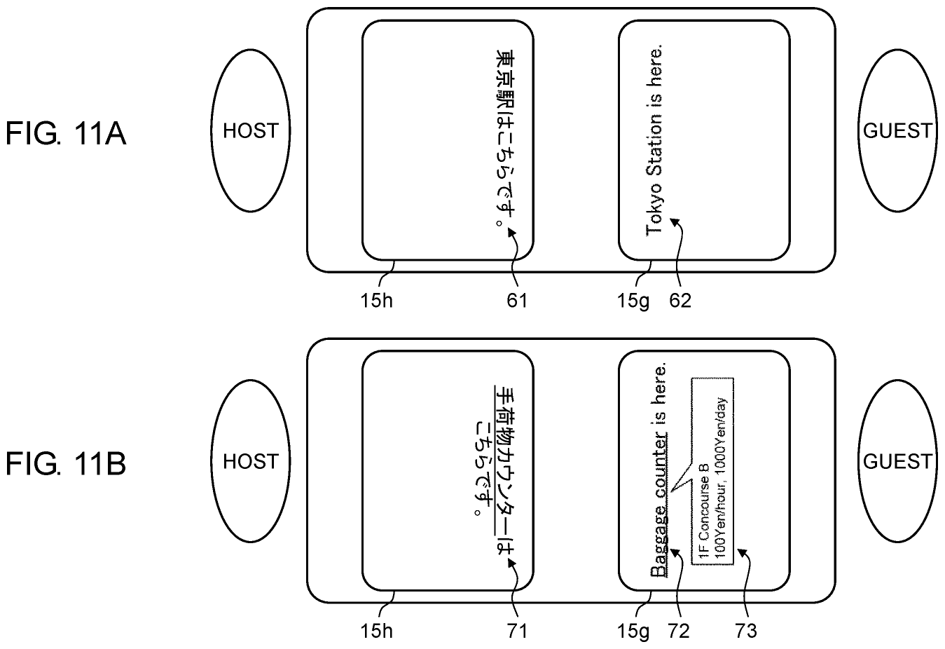

FIG. 11A illustrates a display example of the target translation generated in the regular process (S5). When the target translation is generated in the regular process, the display 14 displays, in a regular manner, both spoken sentence 61 within display area 15h adjacent to the host and target translation 62 within display area 15g adjacent to the guest. For example, the character strings are displayed in black.

FIG. 11B illustrates a display example of the target translation generated in the replacement process (S6). When the target translation is generated in the replacement process, the display 14 displays spoken sentence 71 within display area 15h adjacent to the host with the registered term emphasized and also displays target translation 72 within display area 15g adjacent to the guest with the registered translation term emphasized. More specifically, display 14 underlines character strings of the registered term and its translation. When the target translation is displayed in the replacement process, the display 14 further displays additional information 73 together with target translation 72.

The emphasizing display of a registered term and its translation may be discriminable from the normal display. The emphasizing display method of a registered term and its translation may change depending on a class (e.g., place name or food). As an example, in the emphasizing display for the class “place name”, black character strings may be underlined. In the emphasizing display for the class “food”, character strings may be chromatically colored. As another example, in the emphasizing display for the class “place name”, character strings may be red-colored, and in the emphasizing display for the class “food”, character strings may be blue-colored.

As described above, translation device 1 in this exemplary embodiment displays, in an emphasizing manner, a registered term contained in a spoken sentence and a registered translation term contained in a target translation. The host (speaker) can visually perceive emphasizing display of the spoken sentence, thereby realizing that the replacement process has been performed. In other words, the host (speaker) can visually perceive the emphasizing display of the spoken sentence, thereby confirming that a registered translated term registered in registered word dictionaries 31 is contained in the target translation. In addition, the emphasizing display of the target translation allows the guest to easily find the registered translation term in the target translation. The registered term registered in registered word dictionaries 31 can be a term that the host intends to show the guest accurately. In other words, the registered term can be a term intended to draw guest's interest. Displaying a registered translated term in an emphasizing manner improves visibility of notable terms.

### 1-4. Effect and Others

As described above, translation device 1 according to this exemplary embodiment acquires an original sentence (e.g., spoken sentence) expressed in a first language (e.g., Japanese) and displays a target translation that is a translation of the original sentence expressed in a second language (e.g., English). Translation device 1 includes storage unit 20, replacing unit 22a, communication unit 18, restoring unit 22b, and display 14 (an example of a display unit). Storage unit 20 stores registered word dictionaries 31 (first information) and substitute word dictionary 32 (second information). Each registered word dictionary 31 contains a target term (registered term) and a target translated term that is a translation of the target term (a translation of the registered term) in association with each other. Substitute word dictionary 32 contains a substitute term and a substitute translated term that is a translation of the substitute term (a translation of the substitute term) in association each other. The target term is to be replaced with the substitute term. The target and substitute terms are expressed in the first language. The target and substitute translated terms are expressed in the second language. Replacing unit 22a replaces the registered term in the original sentence with the substitute term to generate a processed sentence. Communication unit 18 outputs the processed sentence to translation server 4 (an example of a first external device) and acquires a provisional translation expressed in the second language that is a translation of the processed sentence. The first external device having a function of making translation from the first language into the second language. Restoring unit 22b changes, in the provisional translation, the substitute translated term to the target translated term to generate the target translation. Display 14 displays the target translation with the target translated term emphasized. The emphasizing display method includes at least one of a chromatic color, an underline, a surrounding line, a slanted letter, a capitalized letter, and a bold letter.

Displaying, in an emphasizing manner, the registered translation term contained in the translated sentence enables a guest to easily find the registered translation term in the translated sentence. The registered term is a technical term used only in any specific field or a term used only in a certain place or region. The registered term registered in each registered word dictionary 31 corresponds to a term that the host intends to show the guest accurately and draw guest's interest. Displaying the registered translation term in an emphasizing manner improves visibility of a notable term.

Display 14 displays the spoken sentence with the registered term emphasized. The host (speaker) can visually perceive emphasizing display of the spoken sentence, thereby realizing that the replacement process has been performed. In other words, the host (speaker) can visually perceive the emphasizing display of the spoken sentence, thereby confirming that a translation of a registered term registered in registered word dictionaries 31 is contained in the translated sentence.

Registered terms are classified into some classes indicating types of the registered terms and registered in respective registered word dictionaries 31. Substitute word dictionary 32 contains a substitute term for each class. Replacing unit 22a determines which of the substitute terms is to be used instead of each of the registered terms in the spoken sentence, based on the classes. The emphasizing display method of the registered translation term contained in the target translation may change depending on the class.

Each registered word dictionary 31 may further contain additional information related to the registered term. When the registered term is replaced with the substitute term or when the registered translation term is restored, display 14 may display the additional information together with the target translation. This enables the guest to view a notable term and related information together.

### Second Exemplary Embodiment

Some other exemplary embodiments of translation device 1 will be described. In the foregoing first exemplary embodiment, when a spoken sentence contains a registered term, translation device 1 displays the registered term and its translation in an emphasizing manner. However, there are cases where a spoken sentence does not contain a registered term but nevertheless a target translation of the spoken sentence contains a registered translation term. This exemplary embodiment, if a spoken sentence does not contain a registered term but a target translation of the spoken sentence contains a registered translation term, employs a display method described below.

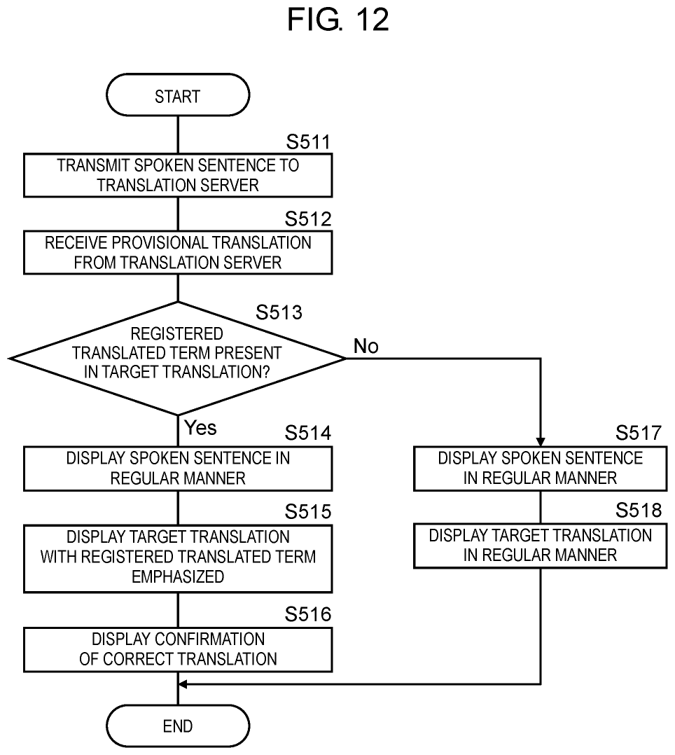

FIG. 12 illustrates details of a regular process (S5) according to a second exemplary embodiment in which a target translation of the spoken sentence is generated and displayed when no registered term is present in a spoken sentence (No at S4). Steps S511, S512, S517, and S518 in FIG. 12 are identical to Steps S501, S502, S503, and S504, respectively, in FIG. 8 exemplifying the first exemplary embodiment. In this exemplary embodiment, however, Steps S513 to S516 are added as new steps.

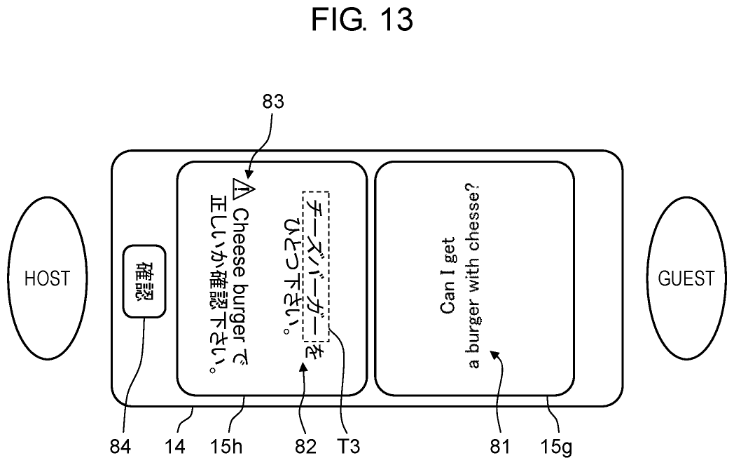

Hereinafter, it is expected that translation device 1 translates face-to-face conversation between a host (e.g., salesclerk) who speaks Japanese and a guest (e.g., shopper) who speaks English. More specifically, it is expected that the guest speaks “Can I get a burger with cheese?”, and translation device 1 displays, as a translation result, text of target translation 82 (see FIG. 13) toward the host. In the example described below, Japanese term T3 meaning “cheese burger” and its English translation “cheese burger” are registered in registered word dictionaries 31. However, “burger with cheese” is not registered in registered word dictionaries 31. Since a speaker (guest) speaks English in this exemplary embodiment, the “cheese burger” is referred to as the “registered term”, whereas term T3 expressed in a language (Japanese) used for translation is referred to as the “registered translation term”.

When receiving text data on a translated sentence from translation server 4, controller 22 in translation device 1 determines whether the translated sentence contains the registered translation term (S513). When the translated sentence contains the registered translation term (Yes at S513), controller 22 displays the spoken sentence in a regular manner (S514). In addition, controller 22 displays the translated sentence with the registered translation term emphasized (S515). In this case, the spoken sentence does not contain the registered term, but translated sentence contains the registered translation term. Therefore, controller 22 displays a confirmation sentence for use in confirming whether the translation result is correct (S516). It should be noted that Steps S514, S515, and S516 regarding a display process may be performed either simultaneously or in a sequence.

FIG. 13 illustrates a display example at Steps S514 to S516. Spoken sentence 81 “Can I get a burger with cheese?” is displayed in a regular manner (e.g., in black), because the term “burger with cheese” is not registered in registered word dictionaries 31. In contrast, target translation 82 is displayed with the registered translation term, or term T3, emphasized (e.g., with slanted letters).

In order to confirm whether the translation is correct, namely, whether the order is a cheese burger, confirmation sentence 83 is displayed within display area 15h adjacent to the host. Confirmation sentence 83 contains the registered term “cheese burger” instead of the speech “burger with cheese”. The host views confirmation sentence 83 and thereby will be able to ask the guest whether the translation is correct, in a subsequent conversation. In short, the host can ask the guest whether “a burger with cheese” that he or she has ordered corresponds to a “cheese burger”, in the conversation. In addition to confirmation sentence 83, display 14 may further display check button 84 for displaying a sentence that prompts the guest to confirm whether the translation is correct, within an area adjacent to the host. Furthermore, in response to host's touch on check button 84, display 14 may display an English sentence for use in confirming whether “cheese burger” is correct, within display area 15g adjacent to the guest.

The method (S606, S607) in which the spoken sentence and the target translation are displayed in an emphasizing manner during the replacement process may be either different from or identical to the method (S515) in which the target translation that contains the registered translation term is displayed in an emphasizing manner during the regular process. For example, when the emphasizing display (S606, S607) is given during the replacement process, character strings may be displayed in red. When the emphasizing display (S515) is given during the regular process, a character string may be displayed in blue.

As described above, translation device 1 in this exemplary embodiment, if a spoken sentence does not contain a registered term but a target translation contains the registered translated term, displays the target translation with a registered translation term emphasized. The method in which the registered translation term in the target translation is displayed in an emphasizing manner when the spoken sentence does not contain the registered term but the target translation contains the registered translated term may be different from the method in which the registered translation term in the target translation is displayed in an emphasizing manner when the spoken sentence contains the registered term. If the spoken sentence does not contain the registered term but the target translation contains the registered translation term, translation device 1 in this exemplary embodiment also displays confirmation sentence 83 for use in confirming whether the target translation is correct. Displaying confirmation sentence 83 in this manner improves visibility of the registered translation term (notable term). The host views the registered translated term (e.g., term T3) in the target translation 82 and the registered term (e.g., cheese burger) in confirmation sentence 83 and thereby can recognize guest's demand. In this case, the host can recognize that a guest's order is possibly a cheese burger. Moreover, translation device 1 displays a portion of target translation 82 in an emphasizing manner and further displays confirmation sentence 83, thereby allowing the host to recognize the risk of the translation being incorrect.

### Other Exemplary Embodiments

The first and second exemplary embodiments have been described above as examples of the technique disclosed in this application. However, the technique of the present disclosure is not limited to those first and second exemplary embodiments, and also applicable to other exemplary embodiments that undergo some modifications, replacements, additions, and omissions, for example, as appropriate. Novel exemplary embodiments may also be contemplated from a combination of some components of the foregoing first and second exemplary embodiments. Some other exemplary embodiments will be described below as examples.

In the replacement process in the foregoing first exemplary embodiment, translation device 1 displays a spoken sentence with a registered term emphasized (S606) and also displays a target translation of the spoken sentence with a registered translation term emphasized (S607). However, displaying one or both of the spoken sentence and the target translation in an emphasizing manner may be performed in response to a user's predetermined operation. As a specific example, translation device 1 may display a host's spoken sentence with a registered term emphasized, and further displays a target translation of the spoken sentence in a regular manner. Then, in response to host's touch on a predetermined button, a display area of the registered word, or its adjacent area, translation device 1 may display the target translation with a registered translated term emphasized. Alternatively, translation device 1 may display a guest's spoken sentence with a registered term emphasized, and further displays a target translation of the spoken sentence in a regular manner. Then, in response to guest's touch on a predetermined button, a display area of the registered word, or its adjacent area, translation device 1 may display the target translation with a registered translated term emphasized.

Methods of displaying respective registered terms in an emphasizing manner may be preset. More specifically, for each registered term, the emphasizing display method, such as a method using an underline, a surrounding line, a slanted line, a capitalized letter, a bold letter, or a chromatic color may be registered in registered word dictionaries 31. In this case, the method of displaying the spoken sentence and the target translation in an emphasizing manner may conform to the emphasizing display method registered in registered word dictionaries 31. When translation device 1 provides the emphasizing display in response to a user's predetermined operation, a manner of this predetermined operation may be registered for each registered term in registered word dictionaries 31. In this case, translation device 1 may display the spoken sentence and the target translation in an emphasizing manner after the user has performed the predetermined operation registered in registered word dictionaries 31.

During the replacement process in the foregoing first exemplary embodiment, translation device 1 may display a class name together with the target translation (S607). As in the example of FIG. 11B, translation device 1 may display a balloon in which characters of a class name “place name” are expressed, near the characters of the translation “baggage counter” of the registered term. Likewise, when displaying the spoken sentence, translation device 1 may display a balloon in which a class name is expressed, near the registered term (S606).

A proper name and a term that is similar to this proper name and likely to be mentioned may be registered in registered word dictionaries 31 in relation to each other. Even if a spoken sentence does not contain the proper name, translation device 1 may display the proper name when displaying the spoken sentence (S606). For example, a proper name “baggage counter” and a similar term “baggage reception counter” may be registered in registered word dictionaries 31 in relation to each other. When a speaker speaks “baggage reception counter is here”, translation device 1 may perform the replacement process to display the spoken sentence “baggage counter is here”.

Translation device 1 in the foregoing exemplary embodiments may further have a reverse translation function of translating a translation result into an original language (e.g., Japanese); the translation result is a translated sentence obtained by translating a speech from one language (e.g., Japanese) into another language (e.g., English). In this case, translation device 1 transmits a provisional translation to translation server 4 and acquires a provisional reverse translation that is a reverse translation of the provisional translation from translation server 4. In the example of FIG. 3, translation device 1 transmits text data on the provisional translation “Tokyo station is here.” to translation server 4 and acquires text data on sentence W2, as a provisional reverse translation, from translation server 4. Translation device 1 refers to replacement information 33, then replaces term T2, which is a substitute term contained in the provisional reverse translation, or sentence W2, with a registered term, or term T1, and displays a target reverse translation. In this case, translation device 1 may display the target reverse translation with the registered term emphasized, as illustrated in FIG. 1. The method of displaying the target reverse translation with the registered term emphasized may be identical to the method of displaying the spoken sentence with the registered term emphasized. In the example of FIG. 1, for example, both the methods of displaying the registered term in an emphasizing manner use an underline. Consequently, a user can easily understand a relationship between the registered terms in the spoken sentence and in the target reverse translation.

In the above exemplary embodiments, voice recognition server 3 performs the voice recognition, translation server 4 performs the translation, and voice synthesis server 5 performs the voice synthesis. However, the present disclosure is not limited to this configuration. Alternatively, translation device 1 may perform at least one of the voice recognition, the translation, and the voice synthesis. For example, translation device 1 (terminal) may perform functions the same as in voice recognition server 3, translation server 4, and voice synthesis server 5. Translation device 1 may solely perform all processes related to the translation. In this case, translation device 1 does not necessarily have to include communication unit 18.

In the foregoing exemplary embodiments, the translation is made between Japanese and English as an example. However, the present disclosure is not limited to the translation between Japanese and English. The translation may be made between two of other languages (e.g., Chinese, German, French, Spanish, Korean, Thai, Vietnamese, and Indonesian).

In the foregoing exemplary embodiments, translation device 1 translates spoken sentences received via microphone 10, but may translate input sentences other than spoken sentences. More specifically, translation device 1 may translate input sentences received via a keyboard or a mouse. When translating a sentence such as a spoken sentence or an input sentence, translation device 1 of the present disclosure replaces a target term in the sentence with a substitute term. Then, translation device 1 restores a target translated term which has been replaced with the substitute term, based on a substitute translated term contained in the provisional translation. After that, translation device 1 displays the target translation with a target translated term emphasized.

As described above, the exemplary embodiments have been described as examples of the technique in the present disclosure. For that purpose, the accompanying drawings and the detailed description have been provided.

To illustrate the above technique, the components described in the accompanying drawings and the detailed description can include not only components necessary to solve the problem but also components unnecessary to solve the problem. For this reason, it should not be promptly recognized that those unnecessary components are necessary just because those unnecessary components are described in the accompanying drawings and the detailed description.

Since the above exemplary embodiment is intended to illustrate the technique in the present disclosure, various modifications, replacements, additions, and removals, for example, can be made without departing from the scope of the accompanying claims or the equivalent thereof.

### INDUSTRIAL APPLICABILITY

The present disclosure is applicable to translation devices that make translation, based on speaker's voices.

### REFERENCE MARKS IN THE DRAWINGS

1: translation device
2: network
3: voice recognition server
4: translation server (first external device)
5: voice synthesis server
10: microphone (input unit)
12: speaker (output unit)
14: display (display unit)
16: touch panel (operation unit)
18: communication unit
20: storage unit
22: controller
22a: replacing unit
22b: restoring unit
31: registered word dictionary (first information)
32: substitute word dictionary (second information)
33: replacement information
14h, 14g: speech icon
15h, 15g: display area
100: translation system

1. A translation device that acquires an original sentence expressed in a first language and displays a target translation that is a translation of the original sentence expressed in a second language, the translation device comprising:
a storage unit that stores first information and second information, the first information containing a target term and a target translated term that is a translation of the target term in association with each other, the second information containing a substitute term and a substitute translated term that is a translation of the substitute term in association with each other, the target term being to be replaced with the substitute term, the target and substitute terms being expressed in the first language, the target and substitute translated terms being expressed in the second language;
a replacing unit that replaces the target term in the original sentence with the substitute term to generate a processed sentence to be translated;
a communication unit that outputs the processed sentence to a first external device and acquires from the first external device a provisional translation expressed in the second language that is a translation of the processed sentence, the first external device having a function of making translation from the first language into the second language;
a restoring unit that changes, in the provisional translation, the substitute translated term to the target translated term to generate the target translation; and
a display unit that displays the target translation with the target translated term emphasized.

2. The translation device according to claim 1, wherein
the display unit displays the original sentence with the target term emphasized.

3. The translation device according to claim 2, wherein
the first external device further has a function of making translation from the second language into the first language,
the communication unit further outputs the provisional translation to the first external device and acquires from the first external device a provisional reverse translation expressed in the first language that is a reverse translation of the provisional translation,
the restoring unit changes, in the provisional reverse translation, the substitute term to the target term to generate a target reverse translation that is a reverse translation of the original sentence, and
the display unit displays the target reverse translation with the target term emphasized.

4. The translation device according to claim 3, wherein
a method of emphasizing the target term in the target reverse translation is identical to a method of emphasizing the target term in the original sentence.

5. The translation device according to claim 1, wherein
the first external device further has a function of making translation from the second language into the first language,
the communication unit further outputs the provisional translation to the first external device and acquires from the first external device a provisional reverse translation expressed in the first language that is a reverse translation of the provisional translation,
the restoring unit changes, in the provisional reverse translation, the substitute term to the target term to generate a target reverse translation of the original sentence, and
the display unit displays the target reverse translation with the target term emphasized.

6. The translation device according to claim 1, wherein
the target term is one of target terms in the first information, the target terms being registered to a respective one of classes that indicate types of the target terms,
the substitute term is one of substitute terms in the second information, the substitute terms being registered to a respective one of the classes, and
the replacing unit determines which of the substitute terms is to be used instead of each of the target terms in the original sentence, based on the classes.

7. The translation device according to claim 6, wherein
a method of emphasizing the target term in the target translation changes depending on the classes.

8. The translation device according to claim 1, wherein
the first information further contains additional information related to the target term, and
when the target term is replaced with the substitute term or when the substitute translated term is changed to the target translated term, the display unit displays the additional information together with the target translation.

9. The translation device according to claim 1, wherein
when the original sentence does not contain the target term but the target translation contains the target translated term, the display unit displays the target translation with the target translated term emphasized.

10. The translation device according to claim 9, wherein
a method of emphasizing the target translated term when the original sentence does not contain the target term but the target translation contains the target translated term is different from a method of emphasizing the target translated term when the original sentence contains the target term.

11. The translation device according to claim 1, wherein
when the original sentence does not contain the target term but the target translation contains the target translated term, the display unit further displays a confirmation sentence for use in confirming whether the target translation is correct.

12. The translation device according to claim 1, wherein
the target term is a technical term used only in any specific field or a term used only in a certain place or region.

13. The translation device according to claim 1, wherein
a method of emphasizing the target translated term includes at least one of a chromatic color, an underline, a surrounding line, a slanted letter, a capitalized letter, and a bold letter.

14. The translation device according to claim 1, further comprising an input unit that acquires a speech, wherein
the communication unit outputs voice data of the speech to a second external device and acquires the original sentence in accordance with the voice data from the second external device.
